(19) United States
(12) Patent Application Publication
(10) Pub. No.: US 2026/0312832 A1
(43) Pub. Date: Oct. 8, 2026

(54) CENTRALIZED AUTHORIZATION FOR SECURE SHELL ACCESS

(71) Applicant: CyberArk Software Ltd., Petach-Tikva (IL)

(72) Inventors: Justin HANSEN, Roosevelt, UT (US); Aaron HIXSON, Payson, UT (US); Andrey NAZINKIN, Peterborough (GB)

(73) Assignee: CyberArk Software Ltd., Petach-Tikva (IL)

(21) Appl. No.: 19/424,344

(22) Filed: Dec. 18, 2025

Related U.S. Application Data
(60) Provisional application No. 63/782,763, filed on Apr. 3, 2025.

(51) Int. Cl. H04L 9/40; H04L 9/08; H04L 9/32

(52) U.S. Cl. CPC H04L 9/40; H04L 9/0825; H04L 9/3247

(57) ABSTRACT

Disclosed embodiments relate to non-transitory computer readable media, systems, and methods for providing centralized authorization of one or more cryptographic data elements. Disclosed techniques include collecting configuration data stored across a plurality of local machines. Disclosed techniques include storing the configuration data in a rules database associated with a centrally managed authorization application. Disclosed techniques include receiving a request to access a network resource, the request comprising. Disclosed techniques include a cryptographic data element, an identification of a principal making the access request, an identifier of the network resource, and a metadata element. Disclosed techniques include creating a record of the request. Disclosed techniques include determining, through the authorization application, whether the principal is authorized to access the network resource. Disclosed techniques include transmitting a response to the request, wherein the response is based on the cryptographic data element, the identification of the principal, the identifier of the network resource, processing of the metadata element, or an application of an access policy.

### CROSS REFERENCES TO RELATED APPLICATIONS

This application claims the benefit of priority U.S. Provisional Patent Application No. 63/782,763, filed Apr. 3, 2025. The foregoing application is incorporated herein by reference in its entirety.

### TECHNICAL FIELD

This disclosure relates to systems, methods, apparatuses, and computer-readable media storing instructions to perform operations for providing centralized authorization of one or more cryptographic data elements.

### BACKGROUND

Use of secure shell (“SSH”) access for human and automated access to secure network resources is ubiquitous. Using asymmetric keys as credentials for authentication and authorization is a common technique for enabling SSH access. Typically, by default, any user can create an SSH keypair using cryptographic tools, which may enable the use of the keypair to authenticate the user without involving system administrators or identity security teams. While the use of asymmetric keys can increase security in many cases, the highly autonomous and distributed nature of these keys can create a security risk for organizations. Further, because such keypairs may never expire, organizations face a key sprawl issue in which access is being granted by a key, bypassing password requirements, without the organization being able to identify who is accessing the private key of the keypair. In some instances, organizations may have thousands or millions of keypairs and may not be able to identify the source and use of such keypairs.

Existing approaches to manage this key sprawl issue are mainly focused on managing the SSH key credentials. For example, these approaches may include attempting to discover all instances of public SSH keys and their associated private SSH keys. Administrators and security teams may then rotate or remove existing SSH keypairs after all keypairs have been identified. In other approaches, users may use signed keys or SSH certificates. The SSH certificates may create a single-level trust hierarchy. While these approaches may address the key sprawl issue, there is not a clear and straightforward way for an organization to implement these approaches because such approaches would require updating automated scripts, jobs, and applications that use existing SSH keypairs. Other approaches may include employing a session manager or jump host that require every user to connect to and authenticate with a system using approved and more tightly controlled authentication and authorization policies. Such approaches may work for interactive, human logins, but fail to solve the issue for automated machine-to-machine cases.

The advantageous solutions described herein address these and other technical problems in the fields of application security and network security.

### SUMMARY

The disclosed embodiments describe non-transitory computer readable media, systems, and methods for providing centralized authorization of one or more cryptographic data elements. For example, in an embodiment, a non-transitory computer readable medium may include instructions that, when executed by at least one processor, cause the at least one processor to perform operations for providing centralized authorization of one or more cryptographic data elements. The operations may comprise collecting configuration data stored across a plurality of local machines. The operations may further comprise storing the configuration data in a rules database associated with a centrally managed authorization application. The operations may further comprise receiving a request to access a network resource, the request comprising: a cryptographic data element, an identification of a principal making the access request, an identifier of the network resource, and a metadata element. The operations may further comprise creating a record of the request. The operations may further comprise determining, through the authorization application, whether the principal is authorized to access the network resource. The operations may further comprise transmitting a response to the request, wherein the response is based on the cryptographic data element, the identification of the principal, the identifier of the network resource, processing of the metadata element, or an application of an access policy.

In an embodiment, the operations may further comprise at least one of: creating a new authorization rule or updating an existing authorization rule, based on the record of the request.

In an embodiment, the operations may further comprise wherein creating the new authorization rule comprises: determining that an authorization rule does not exist, based on a query to the rules database, wherein the query includes the cryptographic data element, the identification of the principal, and the identifier of the network resource; and creating the new authorization rule based on the cryptographic data element, the identification of the principal, the identifier of the network resource, or the processing of the metadata.

In an embodiment, the operations may further comprise wherein updating the existing authorization rule comprises: determining that an authorization rule exists, based on a query to the rules engine, wherein the query includes the cryptographic data element, the identification of the principal, or the identifier of the network resource; and updating the existing authorization rule based on the cryptographic data element, the identification of the principal, the identifier of the network resource, or the processing of the metadata.

In an embodiment, the operations may further comprise wherein determining whether the principal has access to the network resource comprises querying the rules engine with the cryptographic data element, the identification of the principal, and the identifier of the network resource.

In an embodiment, the operations may further comprise wherein determining whether the principal has access to the network resource comprises querying the rules database with an authorization rule identifier.

In an embodiment, the operations may further comprise wherein the cryptographic data element comprises a public key corresponding to a private key.

In an embodiment, the operations may further comprise wherein the cryptographic data element comprises: at least one of: a timestamp, the principal, a principal identifier, the network resource, a network resource identifier, the cryptographic data element, a cryptographic data element identifier, an authorization rule identifier, or a representation of an authorization rule locally configured to the network resource; and a cryptographic signature derived by at least one of: a symmetric encryption algorithm, a hashing algorithm, a symmetric key or token, or a signature based on an asymmetric key or certificate.

In an embodiment, the operations may further comprise authorizing the principal.

In an embodiment, the operations may further comprise wherein the metadata element identification is determined by comparing the cryptographic data element to a directory of authorized cryptographic data elements associated with the principal.

In an embodiment, a computer-implemented method for providing centralized authorization of one or more cryptographic data elements, may comprise the operations of collecting configuration data stored across a plurality of local machines In an embodiment, the operations may further comprise storing the configuration data in a rules database associated with a centrally managed authorization application. The operations may further comprise receiving a request to access a network resource, the request comprising: a cryptographic data element, an identification of a principal, an identifier of the network resource associated with the principal, and a data element. The operations may further comprise creating a record of the request. The operations may further comprise determining, through a rules database, whether the principal has access to the network resource. The operations may further comprise transmitting a response to the request, wherein the response is based on the cryptographic data element, the identification of the principal, the identifier of the network resource, processing of the data element, and an application of an access policy.

In an embodiment, the operations may further comprise at least one of: creating a new authorization rule or updating an existing authorization rule based on the record of the request.

In an embodiment, the operations may further comprise wherein creating the new authorization rule comprises: determining that an authorization rule does not exist, based on a query to the rules database, wherein the query includes the cryptographic data element, the identification of the principal, and the identifier of the network resource; and creating the new authorization rule based on the cryptographic data element, the identification of the principal, the identifier of the network resource, and the processing of the data element.

In an embodiment, the operations may further comprise wherein updating the existing authorization rule comprises: determining that an authorization rule exists, based on a query to the rules engine, wherein the query includes the cryptographic data element, the identification of the principal, and the identifier of the network resource; and updating the existing authorization rule based on the cryptographic data element, the identification of the principal, the identifier of the network resource, and the processing of the data element.

In an embodiment, the operations may further comprise wherein determining whether the principal has access to the network resource comprises querying the rules engine with the cryptographic data element, the identification of the principal, and the identifier of the network resource.

In an embodiment, the operations may further comprise wherein determining whether the principal has access to the network resource comprises querying the rules database with an authorization rule identifier.

In an embodiment, the operations may further comprise wherein the cryptographic data element comprises a public key corresponding to a private key.

In an embodiment, the operations may further comprise wherein the cryptographic data element comprises: at least one of: a timestamp, the principal, a principal identifier, the network resource, a network resource identifier, the cryptographic data element, a cryptographic data element identifier, an authorization rule identifier, or a representation of an authorization rules locally configured to the network resource; and a cryptographic signature derived by at least one of: a symmetric encryption algorithm, a hashing algorithm, a symmetric key or token, or a signature based on an asymmetric key or certificate.

In an embodiment, the operations may further comprise authorizing the principal.

In an embodiment, the operations may further comprise wherein the data element identification is determined by comparing the cryptographic data element to a directory of authorized cryptographic data elements associated with the principal.

It is to be understood that both the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 illustrates an example system environment for secure storage and management of secrets, consistent with the disclosed embodiments.

FIG. 2 is a block diagram showing an example computing device, consistent with the disclosed embodiments.

FIG. 3 is a block diagram illustrating an example process for providing centralized authorization of cryptographic data elements, consistent with the disclosed embodiments.

FIGS. 4A-4B together are a block diagram illustrating an example process for providing centralized authorization of cryptographic data elements and creating access rules, consistent with the disclosed embodiments.

FIG. 5 is a block diagram illustrating an example process of caching a record associated with an authorized principal as discussed below using a helper utility to read a rule cache, consistent with the disclosed embodiments.

FIG. 6 is a block diagram illustrating an example process of caching a record associated with an authorized principal, consistent with the disclosed embodiments.

FIGS. 7A-7C together are a block diagram illustrating an example system including an SSH client system, an OpenSSH Daemon, and a helper utility, consistent with the disclosed embodiments.

FIGS. 8A-D together are a block diagram illustrating an example system including a central authorization service, consistent with the disclosed embodiments.

FIGS. 9A-B together are a block diagram illustrating an example process to query a rules engine, consistent with the disclosed embodiments.

FIG. 10 is a block diagram illustrating an example process to create a rule entry, consistent with the disclosed embodiments.

FIG. 11 is a flowchart showing an example process for secure shell access, consistent with the disclosed embodiments.

FIG. 12 is a flowchart showing an example process for secure shell access, consistent with the disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently.

The techniques for providing centralized authorization of cryptographic data elements disclosed herein overcome several technological problems relating to security, efficiency, and functionality in the field of cybersecurity and network security. For example, the disclosed embodiments provide particular techniques for managing and authenticating asymmetric cryptographic keypairs to enable SSH access, in a manner that reduces or eliminates the difficulties created by key sprawl. As described above, key sprawl issues may arise because there are too many sources of keypairs and the organization has no way to track, monitor, and manage the keypairs or the permissions and privileges associated with the keypairs. Using techniques described herein, a system may implement steps to address key sprawl and other problems by moving authorization decisions from individual SSH servers to a centralized and authoritative authorization service that may grant or deny access to network resources and track and record all network access requests. Such techniques may include deploying a helper utility to an organization's SSH servers that may be configured to forward all authorization requests to a centralized authorization server. The centralized authorization server may determine whether or not to grant access to a particular network resource based on the techniques disclosed herein.

For example, a request for access to a network resource may include information about the SSH server, the principal, and a cryptographic data element. By forwarding all authorization requests through a centralized authorization server, the disclosed techniques may establish visibility of all cryptographic data elements within an organization, such as public key credentials, and may track the usage of all cryptographic data elements by principal and target host. Such techniques may create a record of all attempted logins within an organization and whether such requests were allowed or denied.

Additionally, such techniques may also leverage the visibility of the cryptographic data elements and the record of their usage to create access rules based on existing access patterns, modifications to existing access patterns, or new access rules. Further, such techniques may allow pre-existing access rules to continue to be enforced by the organization. This may allow an organization to safely implement the embodiments of the present disclosure while retaining the existing local-to-SSH-server authorization decisions being made before such embodiments are adopted. This may allow the techniques to be deployed by an organization with zero operational impact on the organization's systems and network resources.

Reference will now be made in detail to the disclosed embodiments, examples of which are illustrated in the accompanying drawings.

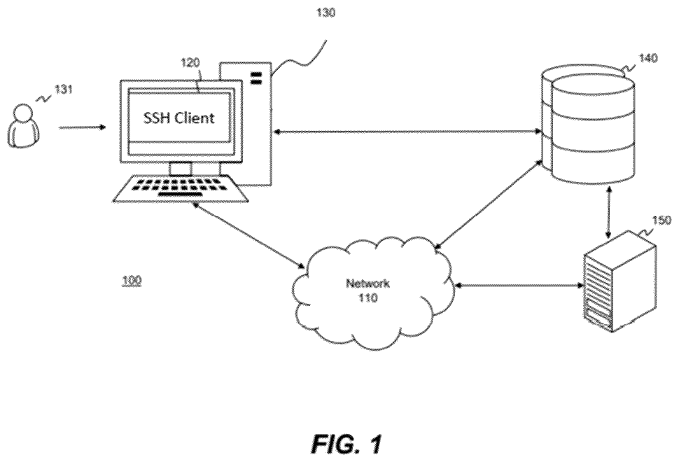

FIG. 1 illustrates an exemplary system 100 providing centralized authorization of cryptographic data elements, consistent with the disclosed embodiments. System 100 may include one or more SSH client 120, one or more computing devices 130, one or more databases 140, and one or more servers 150, as shown in FIG. 1.

The various components may communicate over network 110. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system 100 is shown as a network-based environment, it is understood that the disclosed systems and methods may also be used in a localized system, with one or more of the components communicating directly with each other.

As noted above, system environment 100 may include one or more computing devices 130. Computing device 130 may include any device that may be used for performing various computing operations as described herein. Accordingly, computing devices 130 may be a variety of different types of computing devices capable of developing, storing, analyzing, and/or executing software code. For example, computing device 130 may be a personal computer (e.g., a desktop or laptop), an IoT device (e.g., sensor, smart home appliance, connected vehicle, etc.), a server, a mainframe, a vehicle-based or aircraft-based computer, a virtual machine (e.g., virtualized computer, container instance, etc.), or the like. Computing device 130 may be a handheld device (e.g., a mobile phone, a tablet, or a notebook), a wearable device (e.g., a smart watch, smart jewelry, an implantable device, a fitness tracker, smart clothing, a head-mounted display, etc.), an IoT device (e.g., smart home devices, industrial devices, etc.), or various other devices capable of processing and/or receiving data. Computing device 130 may operate using a Windows™ operating system, a terminal-based (e.g., Unix or Linux) operating system, a cloud-based operating system (e.g., through AWS™, Azure™, IBM Cloud™, etc.), or other types of non-terminal operating systems. In some embodiments, computing device 110 may be a virtual machine (e.g., based on AWS™, Azure™, IBM Cloud™, etc.), container instance (e.g., Docker™ container, Java™ container, Windows Server™ container, etc.), or other virtualized instance. As discussed further below, computing devices 130 may be used for executing software applications, functions, or scripts. For example, identity 131 may interact with SSH client 120 by interfacing with computer device 130.

System 100 may further comprise one or more database(s) 140, for storing and/or executing software or data. For example, database 140 may be configured to store software or code, such as code or build scripts developed using computing device 130. Database 140 may further be accessed by computing device 130, server 150, or other components of system 100 for downloading, receiving, processing, editing, or running the stored software or data. Database 140 may be any suitable combination of data storage devices, which may optionally include any type or combination of subordinate databases, load balancers, dummy servers, firewalls, back-up databases, and/or any other desired database components. In some embodiments, database 140 may be employed as a cloud service, such as a Software as a Service (SaaS) system, a Platform as a Service (PaaS) system, or Infrastructure as a Service (IaaS) system. For example, database 140 may be based on infrastructure or services of Amazon Web Services™ (AWS™), Microsoft Azure™, Google Cloud Platform™, Cisco Metapod™, Joyent™, vmWare™, or other cloud computing providers. In some embodiments, database 140 may be a remote storage location, such as a network drive or server in communication with network 110. In other embodiments database 140 may also be a local storage device, such as local memory of one or more computing devices (e.g., computing device 130) in a distributed computing environment.

System 100 may also comprise one or more server device(s) 150 in communication with network 110. Server device 150 may manage the various components in system 100. In some embodiments, server device 150 may be configured to process and manage requests or commands between computing devices 130 and/or databases 140. In embodiments where application code is accessed within system 100, server device 150 may manage various stages of the process, for example, by managing communications between computing devices 130 and databases 140 over network 110.

SSH client 120 may be any device, component, program, script, or the like, for connecting with other devices within system 100, as described in more detail below. SSH client 120 may be configured to monitor components within system 100, including computing device 130, and may communicate with database 140, or server 150. In some embodiments, SSH client 120 may be implemented as a client that is operated by a user with an identity 131 that may connect to other devices on the network 110. In other embodiments, SSH client 120 may be an automated client or otherwise not require a user to operate the SSH client 120. SSH client 120 may comprise additional elements to facilitate connections with software environments within system 100.

In some embodiments, computing device 130 may be associated with identity 131. Identity 131 may be any entity that may be associated with one or more cryptographic key pairs or privileges required to perform a computing operation. For example, identity 131 may be a human or non-human network identity, such as a user, an account, an application, a process, a service, an electronic signature, or any other entity or attribute associated with one or more components of system environment 100. In some embodiments, identity 131 may be a user requesting to perform a computing operation through computing device 110. In other embodiments, identity 131 may be a machine identity or other automated actor with access to system environment 100.

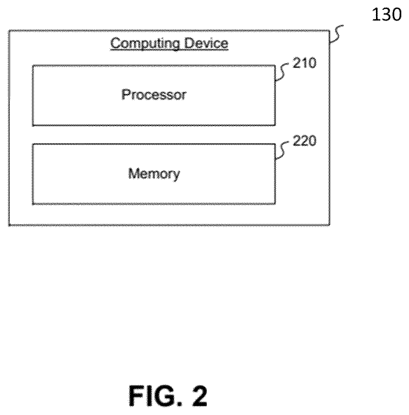

FIG. 2 is a block diagram showing an example computing device 130, consistent with the disclosed embodiments. As described above, computing device 130 may be a device configured to perform (or request to perform) one or more computing operations and may include one or more dedicated processors and/or memories. For example, computing device 130 may include a processor (or multiple processors) 210, and a memory (or multiple memories) 220, as shown in FIG. 2.

Processor 210 may take the form of, but is not limited to, a microprocessor, embedded processor, or the like, or may be integrated in a system on a chip (SoC). Furthermore, according to some embodiments, processor 210 may be from the family of processors manufactured by Intel®, AMD®, Qualcomm®, Apple®, NVIDIA®, or the like. Processor 210 may also be a processor based on the ARM architecture, a processor based on the RISC-V architecture, a mobile processor, a graphics processing unit, or any other form of processor. The disclosed embodiments are not limited to any particular type of processor configured in computing device 110.

Memory 220 may include one or more storage devices configured to store instructions used by the processor 210 to perform functions related to computing device 110 described herein. The disclosed embodiments are not limited to particular software programs or devices configured to perform dedicated tasks. For example, the memory 220 may store a single program, such as a user-level application, that performs the functions associated with the disclosed embodiments, or may comprise multiple software programs. Additionally, the processor 210 may, in some embodiments, execute one or more programs (or portions thereof) remotely located from computing device 130. Furthermore, memory 220 may include one or more storage devices configured to store data for use by the programs. Memory 220 may include, but is not limited to a hard drive, a solid state drive, a CD-ROM drive, a transient or temporary storage device (e.g., a random-access memory (“RAM”)), a peripheral storage device (e.g., an external hard drive, a USB drive, etc.), a network drive, a cloud storage device, or any other storage device.

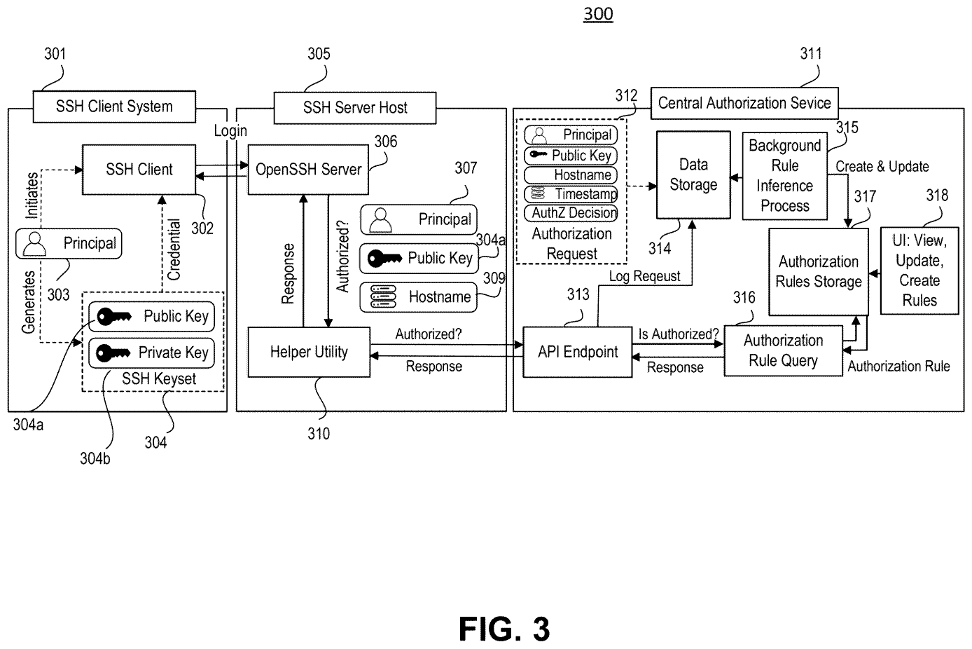

FIG. 3 is a block diagram illustrating an example system 300 for providing centralized authorization of cryptographic data elements, consistent with the disclosed embodiments. The system may include an SSH client system 301. SSH client system 301 may include a principal 303. Principal 303 may be an identity such as identity 131 as described in regard to FIG. 1, or another actor suitable for initiation connections with an SSH service. In some embodiments, principal 303 may generate a SSH keyset 304. In other embodiments, SSH keyset 304 may already exist or may be provided by another source. SSH keyset 304 may include a public key 304a and a private key 304b. Principal 303 may initiate an action in SSH client 302, which may be an SSH client such as SSH client 120 running on a computing device such as computing device 130 as described in regard to FIG. 1. For example, principal 303 may attempt to login to a network resource through an OpenSSH server 306. In other embodiments, principal 303 may send a command to a device on the network. SSH client 302 may receive SSH keyset 304. In some embodiments, principal 303 may provide SSH keyset 304 to SSH client 302 as a credential when principal 303 initiates an action. In other embodiments, SSH client 302 may receive SSH keyset 304 from another suitable source or may have already received SSH keyset 304.

SSH client 302 may be configured to communicate with OpenSSH server 306 and may attempt to login to OpenSSH server 306. SSH client 302 may provide one or more keys in SSH keyset 304 to OpenSSH server 306 within a SSH server host 305. SSH client 302 may provide additional information to OpenSSH server 306 such as a principal identifier 307 associated with principal 303, or hostname 309 associated with the computing device that SSH client 302 is running on. In other embodiments, other identifiers for the computing device may be provided, such as a MAC address, IP address, or other suitable identifiers.

OpenSSH server 306 may provide the received data, including identifier 307, public key 304a, hostname 309, and other data, to a helper utility 310. In some embodiments, the helper utility 310 is the OpenSSH directive AuthorizedKeysCommand. Helper utility 310 may be configured to communicate with an application programming interface (API) endpoint 313 associated with a central authorization service 311. Helper utility 310 may query the central authorization service 311, through the API endpoint 313, whether the principal is authorized to login to the network resource. The API endpoint 313 may log the query request in a storage medium such as a data storage 314. Data storage 314 may be configured to store logs of queries and other authorization requests 312 that are sent from helper utility 310 to the API endpoint 313. Data storage 314 may also be configured to store other data 312 such as identifiers associated with principals, public keys, hostnames, timestamps, authorization determinations, and other relevant data. Data storage 314 may be write optimized storage to enable faster logging and data storage.

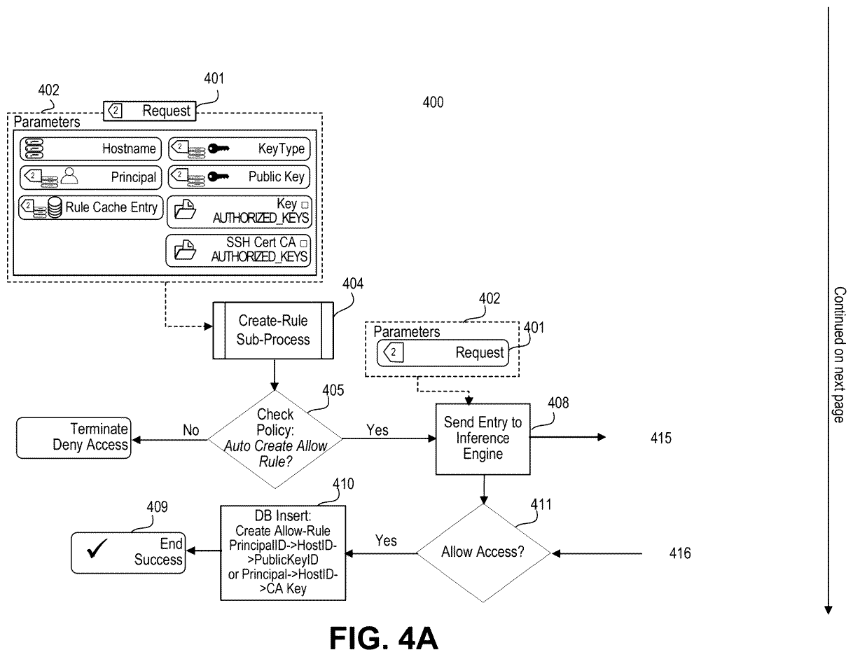

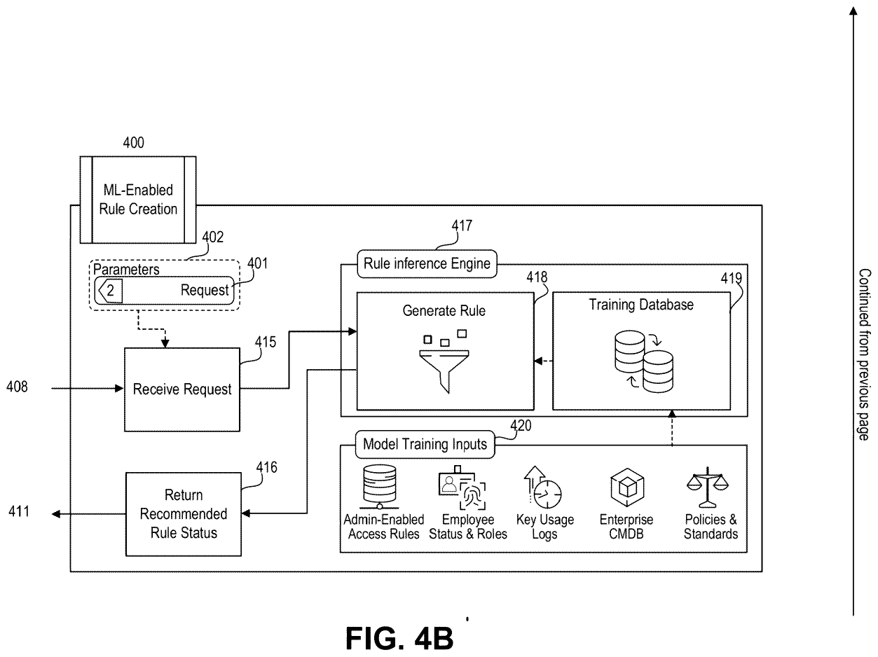

API endpoint 313 may check if the principal is authorized to login to the network resource by performing an authorization rule query 316. The authorization rule query 316 may determine if a rule exists that would authorize principal 303 to login to the network resource. The authorization rule query 316 may check an authorization rules storage 317 for a rule that would authorize the principal 303 to login to the network resource. Rules stored in authorization rules storage 317 may dictate which principals, based on a variety of criteria, are authorized to perform different actions. Criteria may be based on one or more of the following factors: the identity of the principal, the computing device being used to login to the network resource, the network resource, the cryptographic data element (e.g., credential) being used to represent the principal, a data element indicating if the authorization would be approved locally, or other relevant information. The rules stored in the authorization rules storage 317 may be created and updated by a background rules inference process 315. Embodiments of the background rules inference process 315 are described in greater detail in regard to FIG. 4B. Additionally, the rules may be viewed, created, or updated through a user interface (UI) 318.

If a rule exists that authorizes principal 303, the authorization rule query 316 may return an affirmative response to the API endpoint 313. Alternatively, if no rule exists that authorizes principal 303, the authorization rule query 316 may return a negative response to the API endpoint 313. The API endpoint 313 may provide the response to the helper utility 310, which may provide the response to the OpenSSH server 306, which may provide or deny access to the principal 303 through the SSH client 302, based on the response.

FIGS. 4A-4B together are a block diagram illustrating an example process 400 for providing centralized authorization of cryptographic data elements and creating access rules, consistent with the disclosed embodiments. Some embodiments may include creating authorization rules using a machine learning model based on established governance and real-time observation of cryptographic data element usage. For example, a machine learning model may be trained to make decisions on access policies and rules which may be enabled when the explicit configurations and policies would otherwise allow or prevent access.

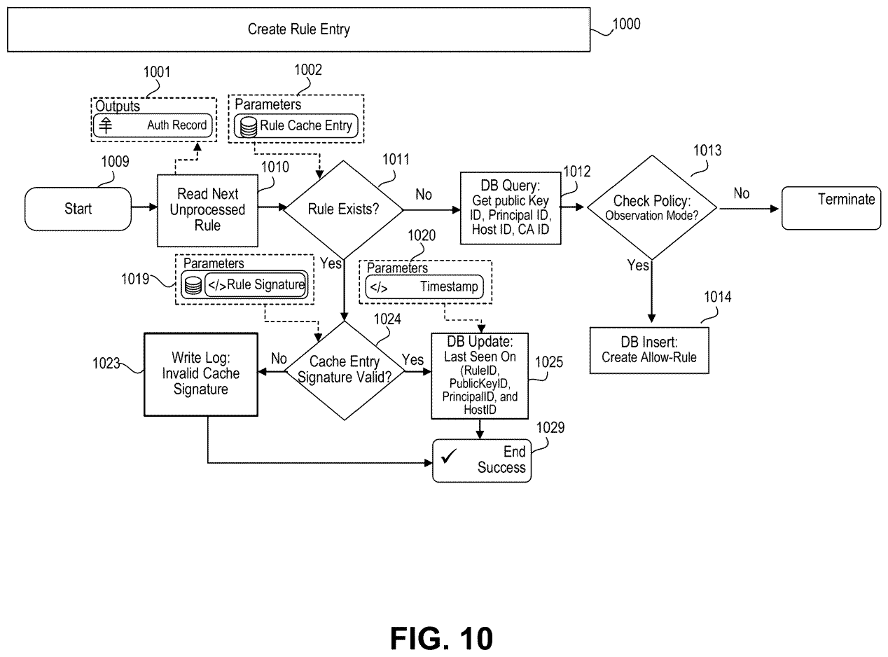

A system configured to perform process 400 may receive a request 401 that may include a set of parameters 402. Parameters 402 may include an identifier associated with a computing device (such as a hostname), an identifier associated with a principal, a rule cache entry, a key type, a public key, an authorized key data, and an authorized key certificate or certificate authority data. Process 400 may include a create-rule sub-process, beginning at step 404. Embodiments of the create-rule sub-process are described in greater detail in regard to FIG. 10. Step 404 may be performed when a request is received, in response to the request or in anticipation of the request, to determine if the request is authorized. The process may determine, at step 405, if the system is configured to automatically create a rule to allow the request, based on the provided parameters. Step 405 may determine if the system is configured in such a way by checking one or more policies that have previously been set. If there is no policy that would automatically create a rule based on the provided parameters, the process may return a negative response to the request and deny the principal access.

If, at step 405, the system is configured to automatically create a rule to allow the principal access, the system may, at step 408, send the entry to an inference engine, which may receive the request at step 415. Additionally, the system may receive additional parameters 402 of the request 401 at step 408 or at step 415.

The rule inference engine 417 may receive the request parameters 402 at step 418, and generate a recommended rule (e.g., a rule that would allow or deny access), or recommended rule status (e.g., active or inactive, consistent with for example policies set by system administrators) based on the parameters 402 and a training database 419. Training database 419 may include a machine learning model trained on model training inputs 420 that may include admin-enabled access rules, employee status & roles data, key usage logs, an enterprise Configuration Management Database (CMDB), and policies and standards. Once the rule inference engine 417 has generated a recommended rule or rule status at step 418, the system may return the recommended rule or rule status at step 416. The system may then determine at step 411, based on preexisting rules, and/or the recommended rule or rule status, whether to allow the requested access. If the system determines that the requested access should be allowed, the system may update the database at step 410 to include the recommended rule that allowed the requested access. At step 409, the system may allow the requested access, based on the new rule in the database.

In some embodiments, the system may determine whether to allow the requested access at step 411 based on existing rules, without input from the rules interference engine 417. In such an embodiment, the system may send the entry to the inference engine at step 408 for processing, but not rely on the inference engine 417 for real time authorization determinations, and proceed directly to step 411.

The disclosed embodiments may also include a file or other record of each authorized principal in a directory. Such record may only be available to a root or administrator user, or the like. The record may be cached, and the cache may be accessed if the central authorization server does not respond to an authorization request. Caching the record of the authorized principals may ensure that the central authorization server remains authoritative while also providing for a high level of availability. The cache files may be stored in a standardized format so that they can be accessed and used without the embodiments of the present disclosure if an organization removes the embodiments of the present disclosure from its systems. This also allows the exact files that were used for the caching process to be leveraged directly by an SSH server as needed. This may allow for a transition of decision making, with the most recent configurations, from the central authorization server back to local servers.

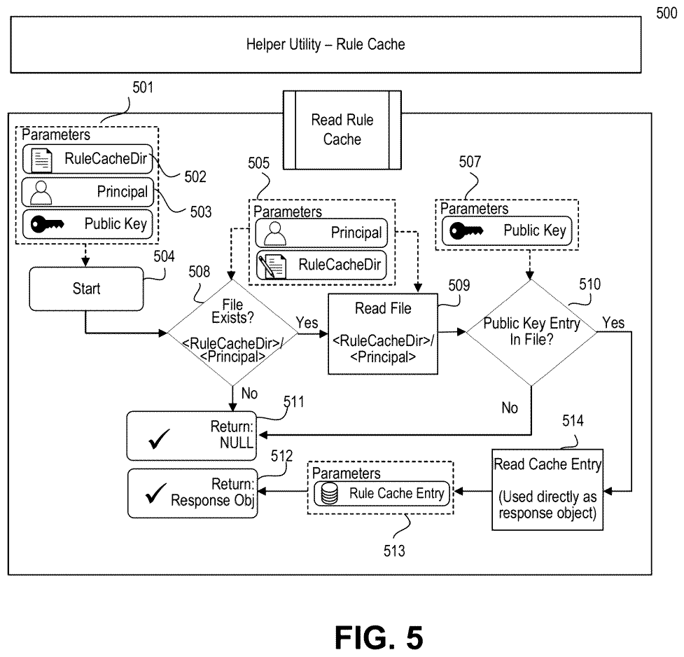

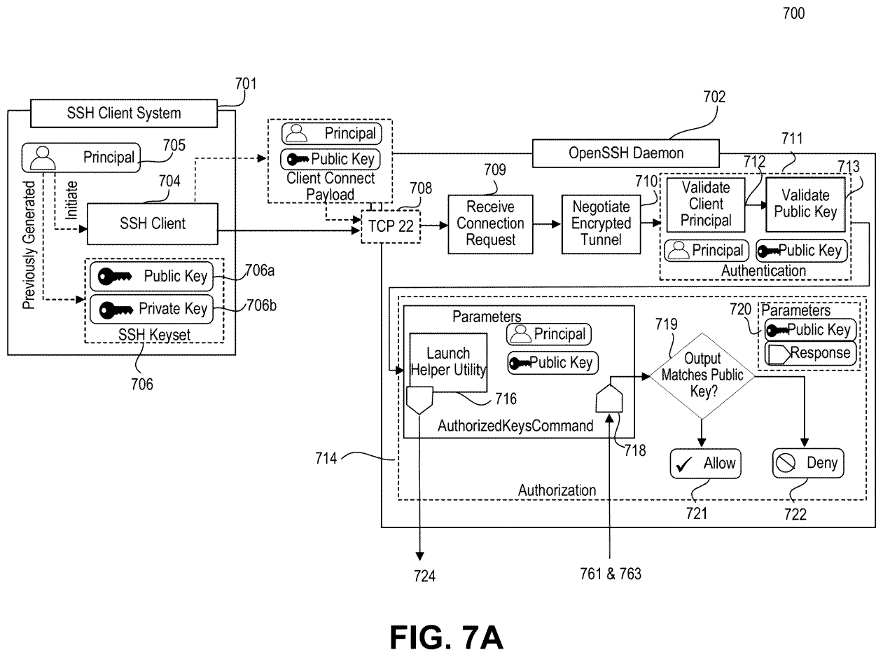

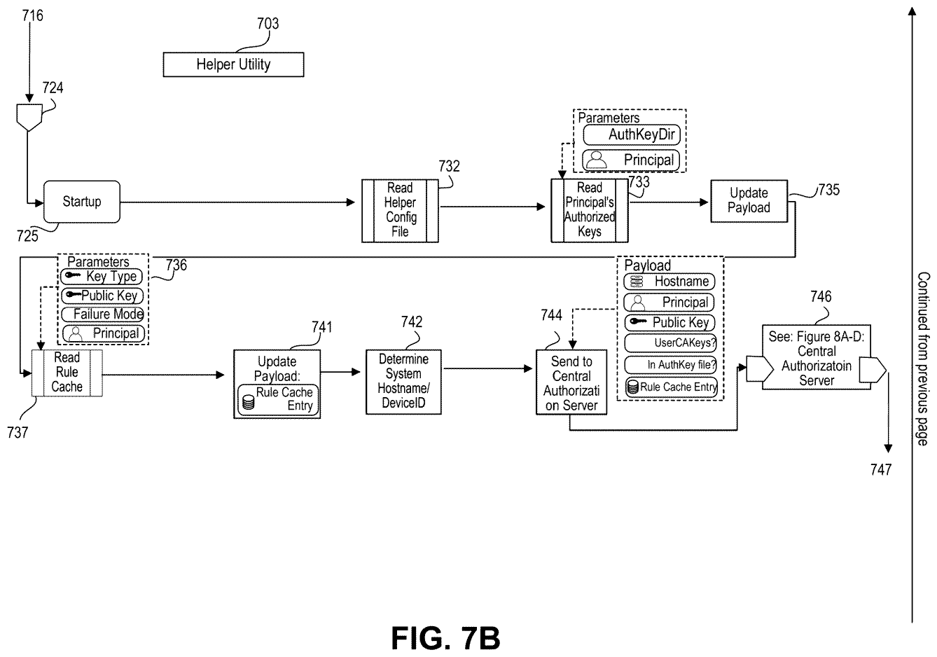

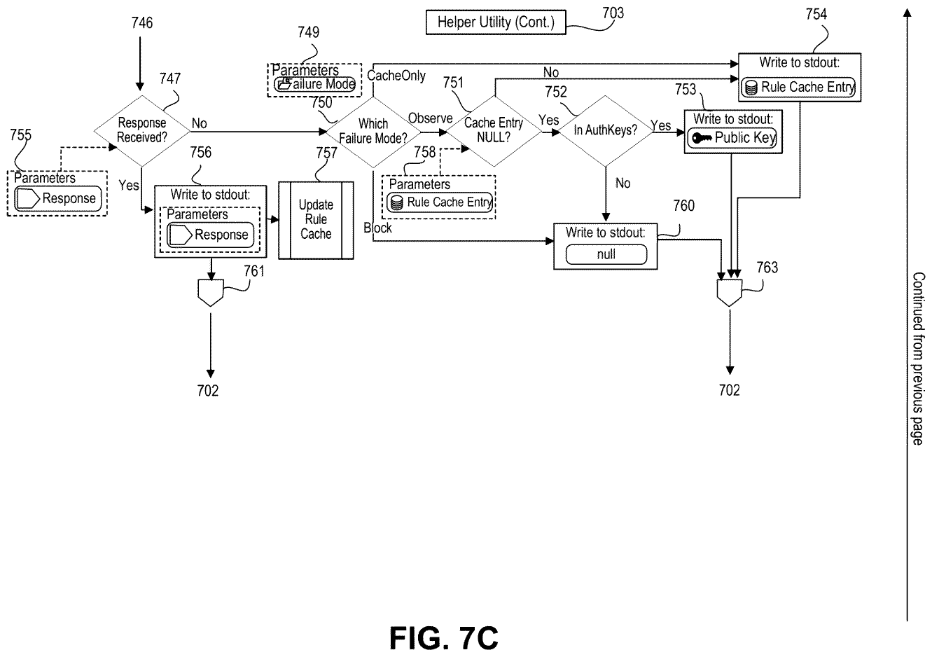

FIG. 5 is a block diagram illustrating an example process 500 of caching a record associated with an authorized principal as discussed below using a helper utility to read a rule cache, consistent with the disclosed embodiments. Embodiments of the helper utility are described below in regards to FIG. 7B. Principal 503 may request access to a network resource in a system, and the request may include parameters 501 such as a public key 507. The request may fail to receive a response from a SSH authentication sever. In order to still authenticate the user, the system may attempt to authenticate the user using rules stored in a rule cache. At step 504, the system may begin a process to read a rule cache. The computing device that the principal uses to send the request may include a rule cache directory 502. At step 508 the process may check if rule cache directory 502 exists. If rules cache directory 502 does not exist, the process may terminate or repeat at step 511 with a null response. If the rules cache directory does exist, the process may, at step 509, read the rules from rules cache directory 502 that are associated with principal 503. At step 510, the process may determine if the public key 507 is associated with an entry in rule cache directory 502. If public key 507 is not associated with any entry in rule cache directory the process may terminate at step 511 with a null response. At step 514, the process may output the rule cache entry 513 that was read at step 509 and public key 507 to the authentication system. The system may then authenticate the user using the rule cache entry 513 as an authentication rule.

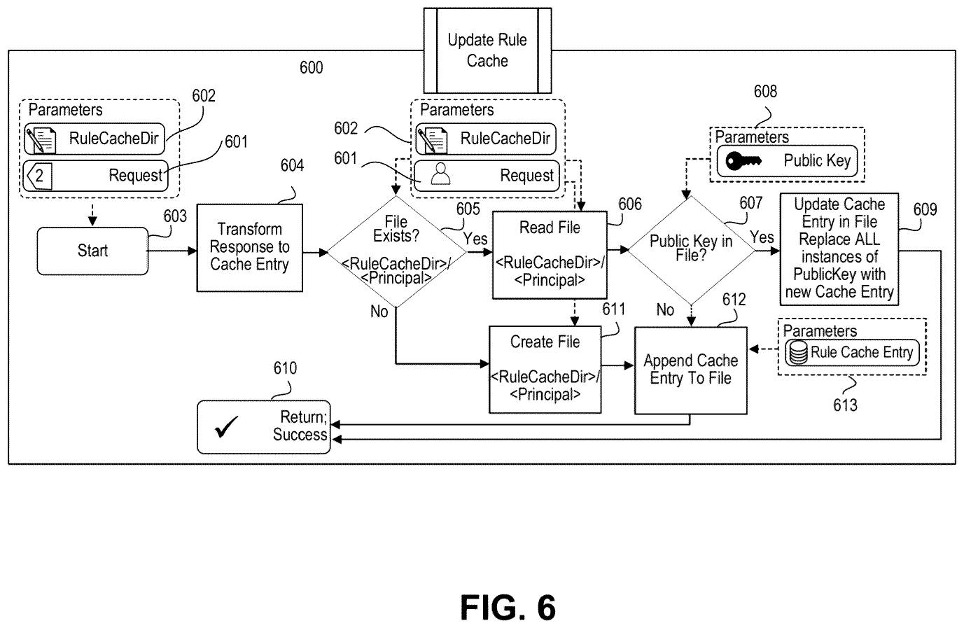

FIG. 6 is a block diagram illustrating an example process 600 of caching a record associated with an authorized principal, consistent with the disclosed embodiments. In some embodiments a principal may request 601 access to a network resource in a system from a computing device. In other embodiments, the principal may send a command to a network resource. The computing device may transmit the request 601 and a rule cache directory 602 from the computing device to a helper utility at step 603. The rule cache directory 602 may include a network location for a rule cache file that is associated with the computing device. The rule cache directory may identify the principal using the computing device. At step 604, the helper utility may receive the response and transform the response from one data structure or file format into the data structure or file format that is compatible with the cache, in order to create a cache entry. At step 605, the helper utility may, based on the rule cache directory and the request itself, determine if the rule cache directory 602 contains a file associated with the principal. The file may contain the principal's public key, timestamp, rule ID, and other relevant data. If the file associated with the principal making the request exists in the rule cache directory 602, the helper utility may continue at step 606 to read the file in the rule cache directory that is associated with the principal making the request. At step 607, the helper utility may determine if the public key 608 associated with the principal is in the file associated with the principal. If there is a public key associated with the principal in the file, the helper utility may update the file in the rule cache directory and replace all existing entries of the principal's public key with a new cache entry at step 609. The helper utility may return a success response 610 to the computing device. The response may notify the computing device that the rule cache was updated.

If the helper utility at step 605 determines the rule cache directory 602 associated with the computing device does not contain a file associated with the principal, the helper utility may, at step 611, create a file associated with the principal in the rule cache directory 602. At step 612, the helper utility may append the cache entry created at step 604, including the principal's public key, to the created file associated with the principal in the rule cache directory. The helper utility may return a response 610 to the computing device. The response may notify the computing device that the file in the rule cache directory was created or updated.

In other embodiments, the disclosed techniques enable enforcement of native SSH options (i.e., no-port-forwarding, no-pty, etc.) according to an organization's existing policies and requirements. The disclosed techniques may additionally enforce policies that are not typical to SSH. For example, the disclosed techniques may enforce a cryptographic data element expiration by measuring the time between when the cryptographic data element was first observed and the current request. If the time exceeds a policy setting, then the disclosed techniques may prevent authorization of access to a requested network resource.

In other embodiments, cryptographic data elements may also be centralized with the central authorization service. This may include a list of trusted user certification authority keys that may be trusted by an SSH server to allow a principal access based on the issuer of the presented cryptographic data element for access. In such embodiments, some or all authorization decisions may be forwarded to the central authorization service, which may observe and incorporate the trusted cryptographic data elements into the access policies and rules. Such an embodiment may prevent authorization decisions from being made locally and would allow for ephemeral issuance of certificates.

FIGS. 7A-7C together are a block diagram illustrating an example system 700 including an SSH client system 701, an OpenSSH Daemon 702, and a helper utility 703, consistent with the disclosed embodiments. The SSH client system may run an SSH client 704 on a computing device operated by principal 705. Principal 705 may have previously generated an SSH keyset 706 that may include a public key 706a and a private key 706b. Principal 705 may initiate a connection or send a command from the computing device to a network resource. For example, the principal may request to connect to a network resource, and the system may send that request to the OpenSSH Daemon 702 through TCP port 22 708. The OpenSSH Daemon 702 may receive the connection request 709 and negotiate an encrypted tunnel 710. Negotiating the encrypted tunnel 710 may include determining which encryption algorithms the SSH client system 701 and OpenSSH Daemon 702 are both compatible with, and then receiving encrypted data and decrypting it using a compatible encryption algorithm. The OpenSSH Daemon 702 may perform authentication 711 to confirm the identity of the principal 705 that sent the connection request 709. The authentication 711 may include validating the principal 712 and the principal's public key 713 to authenticate the source of the request.

OpenSSH Daemon 702 may perform authorization 714 to determine if principal 705 is authorized to make the requested connection. OpenSSH Daemon 702 may launch 716 helper utility 703 and provide it with a set of parameters. The parameters may include an identifier associated with principal 705 and public key 706a.

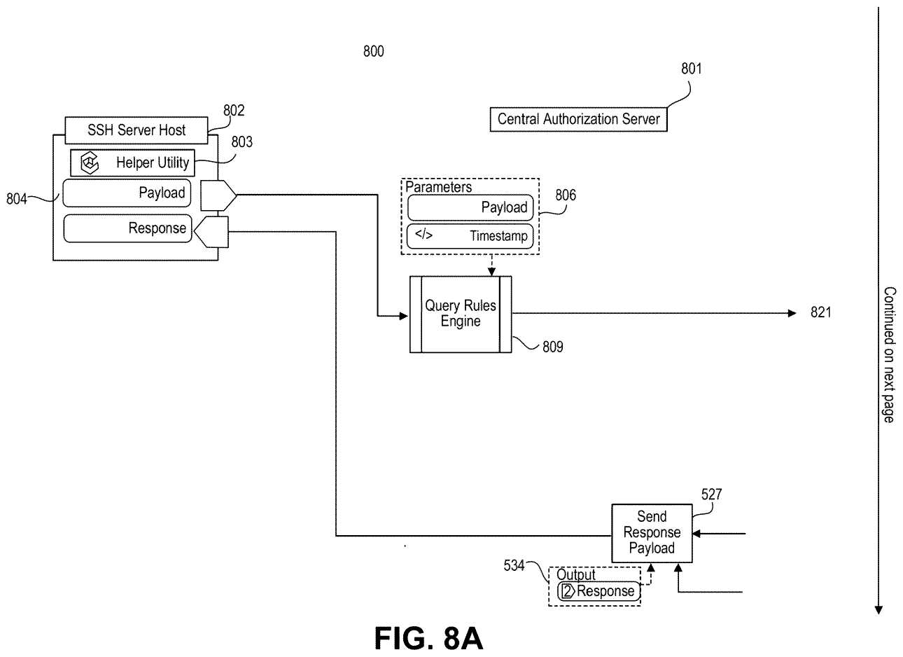

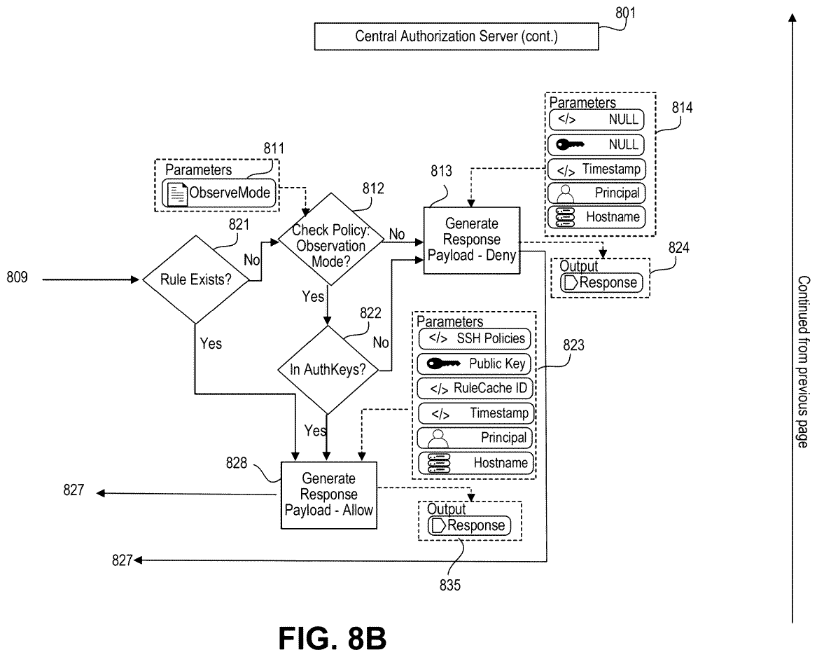

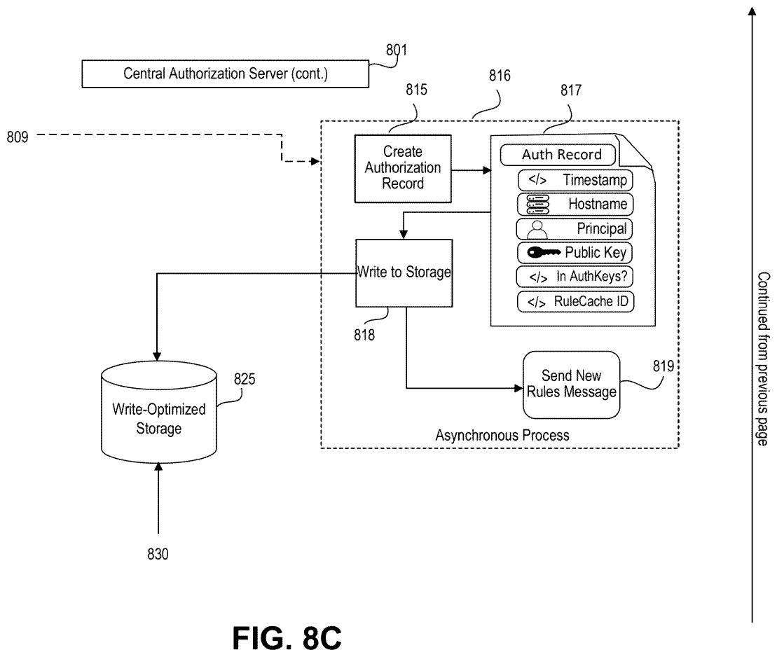

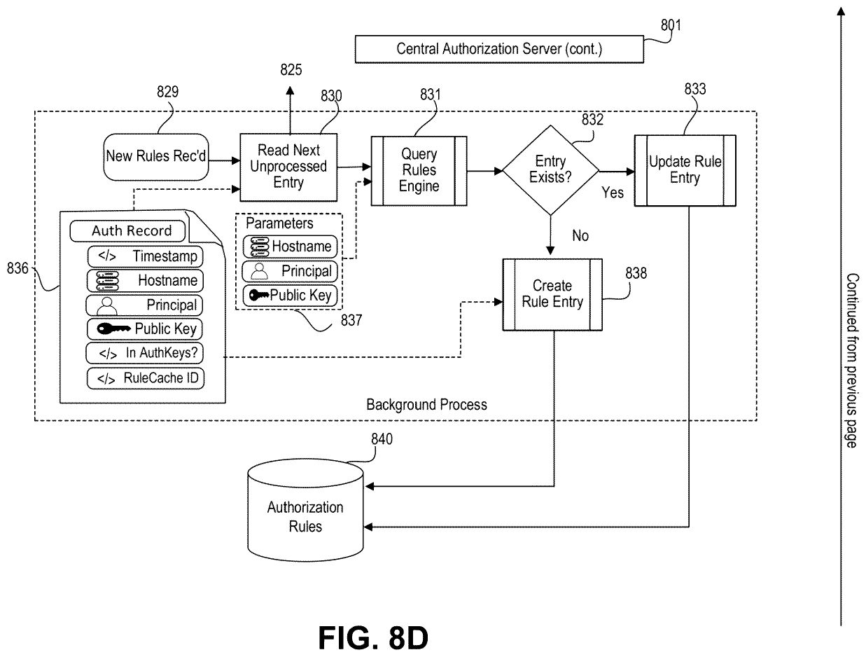

. When helper utility 703 starts 725, helper utility 703 may read the configuration file of the helper utility 732. Helper utility 703 may read the principal's authorized keys from an authorized key file associated with the principal in an authorized key directory 733 and determine if the authorized key directory contains the public key associated with that principal. Helper utility 703 may update a payload 735 to indicate whether the public key associated with the principal is contained in the authorized key directory. Helper utility may read a rule cache 737 and determine if there is a rule cache entry corresponding to a set of parameters 736. Parameters 736 may include the key type, the public key, the failure mode, and the principal. The failure mode may include settings to determine whether cached authorization is required, or if local authorization can be used as a fallback method of authorization. The helper utility may add the rule cache entry to the payload. If there is no rule cache entry, the helper utility may add a null entry to the payload. Helper utility 703 may determine an identifier 742 associated with the computing device and add it to the payload. For example, helper utility 703 may determine the hostname or device ID of the computing device. Helper utility 703 may send the payload 744 to a central authorization server 746. The central authorization server is described further in regard to FIGS. 8A-8D.

Central authorization server 746 may send a response 755, based on the parameters and the determined authorization, to helper utility 703. Helper utility 703 may determine if a response is received 747 from central authorization server 746. If helper utility 703 determines, at 747, a response 755 was received from central authorization server 746, helper utility 703 may output 761 response 755 to OpenSSH Daemon 702 through an output stream such as stdout 756. Helper utility 703 may update a rule cache 757 using response 755. If helper utility 703 does not receive response 755 from central authorization server 746, helper utility 703 may determine a failure mode 750 based on a failure mode parameter 749. Failure modes may include a cache only mode. Cache only mode may refer to a failure mode that uses a rule cache as a backup to an authentication server. If helper utility 703 determines the failure mode is cache only mode, helper utility 703 may output 763 a rule cache entry 754 to OpenSSH Daemon 702 through an output stream such as stdout.

In other embodiments, failure modes may include an observation mode. If helper utility 703 determines the failure mode is observation mode, helper utility 703 may determine if a cache entry is null 751 based on a rule cache entry parameter 758. If helper utility 703 determines the rule cache entry is not null, helper utility 703 may output 763 a rule cache entry 754 to OpenSSH Daemon 702 through output stream such as stdout. If helper utility 703 determines the rule cache entry is null, helper utility 703 may determine if the public key is an authorized key 752. If helper utility 703 determines the public key is an authorized key 752, helper utility 703 may output 763 the public key 753 to OpenSSH Daemon 702 through output stream such as stdout. If helper utility 703 determines the public key is not an authorized key 752, helper utility 703 may output 763 a null response 760 to OpenSSH Daemon 702 through output stream such as stdout.

In other embodiments, failure modes may include a block mode. A block mode may always return a null value to OpenSSH Daemon 702 if helper utility 703 determines a response is not received 747 from central authorization server 746. If helper utility determines 750 the failure mode is block mode, helper utility 703 may output 763 a null response 760 to OpenSSH Daemon 702 through output stream such as stdout. In any failure mode, once helper utility 703 sends an output to OpenSSH Daemon 702 through output 763, helper utility 703 may terminate.

Once OpenSSH Daemon 702 receives a response 718 from helper utility 703, OpenSSH Daemon 702 may determine 719 if the output contains a public key that matches principal's 705 public key 706a. OpenSSH Daemon 702 may make this determination based on parameters 720 that may include the response from helper utility 703 and principal's 705 public key 706a. If OpenSSH Daemon 702 determines the public keys match, OpenSSH Daemon may allow 721 principal 705 to connect to the requested network resource. If OpenSSH Daemon 702 determines the public keys do not match, or that there is no public key in the response from helper utility 703, OpenSSH Daemon 702 may deny 722 principal 705 access to the requested network resource.

FIGS. 8A-D together are a block diagram illustrating an example system 800 including a central authorization service, consistent with the disclosed embodiments, consistent with the disclosed embodiments. A central authorization service may be authorization software that runs on one or more central authorization servers 801 for providing centralized authorization for secure shell access. A SSH server host 802 may include a helper utility 803 that may send an authorization request payload 804 to central authorization server 801. Central authorization server 801 may be a server connected to helper utility 803 through the internet, local network, direct connection, or any other suitable connection. Helper utility 803 may send payload 804 to central authorization server 801 through any suitable connection channel. For example, helper utility 803 may send payload 804 to central authorization server 801 through TCP port 443. Central authorization server 801 may receive authorization request payload 804 and may generate a timestamp of the current time. The timestamp may be associated with the authorization request payload 804. Central authorization server 801 may query a rules engine 809 to determine if a rule exists that allows access 821.

If rules engine 809 determines that a rule exists that allows access 821, central authorization server 801 may generate a response payload 828 that includes a response 835 configured to allow access. Response 835 may include or be generated based on parameters 823. Parameters 823 may include SSH policies, the principal's public key, a rule cache identifier, a timestamp, an identifier associated with the principal, and an identifier associated with the principal's computing device, such as a hostname.

If rules engine 809 determines that no rule exists that allows access 821, central authorization server 801 may determine if an observation mode is enabled 812, based on an observation mode parameter 811. Observation mode may refer to a mode where the system collects and creates authorization rules. Observation mode may only store the collected and created rules without authorizing requests based on those rules, until an administrator enables those rules. If observation mode is enabled 812, central authorization server 801 may determine if the principal's public key is an authorized key 822 by referring to a directory of authorized keys. The directory of authorized keys may not include rules created by the system in global observation mode until an administrator enables those rules. If central authorization server 801 determines the principal's public key is an authorized key 822, central authorization server 801 may generate response payload 828 that includes response 835 configured to allow access.

If rules engine 809 determines that access is not allowed 821, and observation mode is not enabled 812, central authorization server 801 may generate a response payload 813 that includes a response 824 configured to deny access. Response 824 may include or be generated based on parameters 814. Parameters 814 may include a timestamp, an identifier associated with the principal, and an identifier associated with the principal's computing device, such as a hostname. Parameters 814 may include null values for some parameters, such as SSH policies or public key.

If central authorization server 801 determines the principal's public key is not an authorized key 822, central authorization server 801 may generate response payload 813 that includes response 824 configured to deny access.

Once central authorization server 801 has generated response payload 828 or response payload 813, central authorization server 801 may send 827 the response payload to SSH server host 802.

Central authorization server 801 may, when authorization request payload 804 is received (for example at step 809 in FIG. 8A), record the authorization request. Recording the authorization request may be an asynchronous process 816. Central authorization server 801 may create 815 an authorization record 817. Authorization record 815 may include parameters such as a timestamp, an identifier associated with the principal's computing device (such as a hostname), an identifier associated with the principal, the principal's public key, a variable that represents whether the public key is recorded in an authorized key directory, and an identifier associated with a rule cache.

Central authorization server 801 may record the authorization request by writing 818 the authorization record 817 to a storage medium 825. Storage medium 825 may be a write optimized storage medium. Central authorization server 801 may also send a new rules message 819.

Central authorization server 801 may be configured to receive and record rules. Central authorization server 801 may receive and record rules as a background process. When a rule is received 829 (which may be recognized, for example, by receiving the new rules message 819), it may be added to a queue. Central authorization server 801 may read the next unprocessed rule 830 from the queue. Central authorization server 801 may record the rule to storage medium 825. Central authorization server 801 may query rules engine 831 to determine if an entry for the rule exists 832 based on parameters 837. If central authorization server 801 determines that the rule engine does not contain an entry for the rule, central authorization server 801 may create a rule entry 838 based on the rule request and authorization record 836. Central authorization server 801 may add the created rule entry to an authorized rules database 840.

If central authorization server 801 determines that the rule engine does contain an entry for the rule, central authorization server 801 may update a rule entry 833 based on the rule request and authorization record 836. Central authorization server 801 may add or update the updated rule entry in an authorized rules database 840.

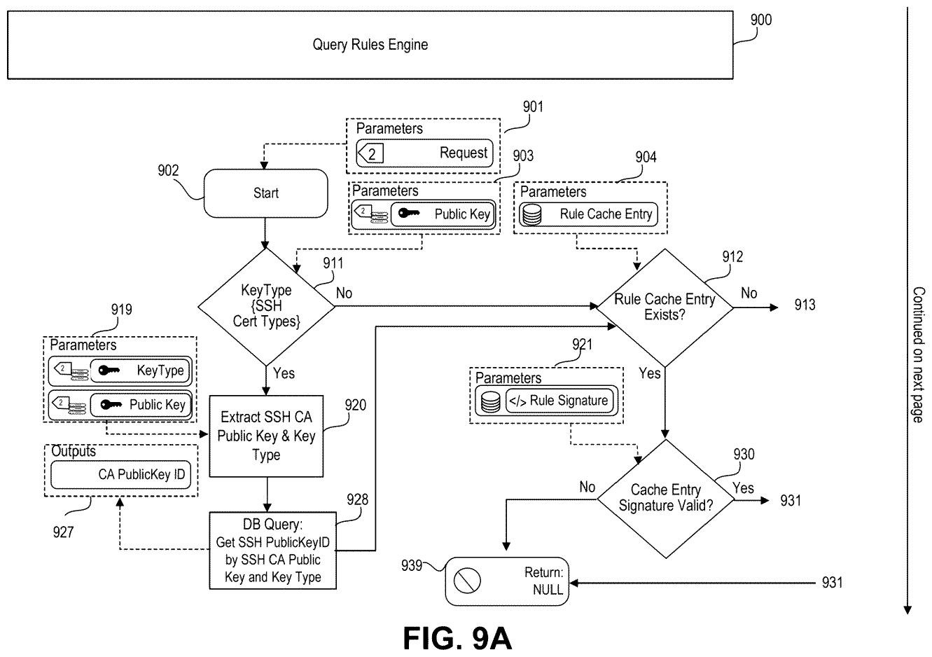

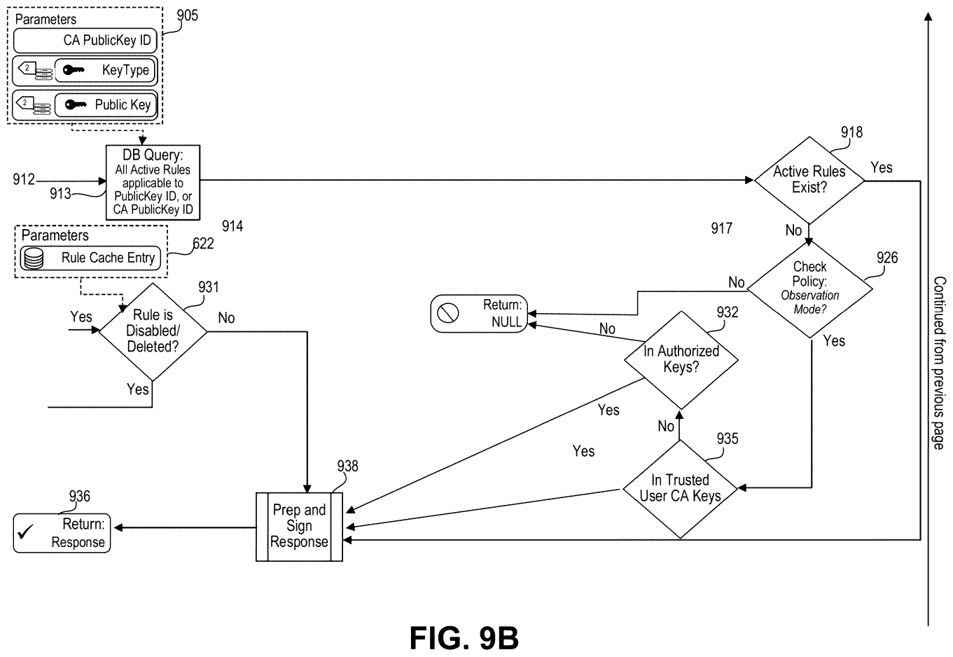

FIGS. 9A-B together are a block diagram illustrating an example process 900 to query a rules engine, consistent with the disclosed embodiments. When a query is sent to a rules engine 902, it may contain parameters 901. The rules engine may determine the key type 911 based on the public key 903 of the principal who queried the rules engine. The key type may correspond to the cryptographic algorithm used to generate the key.

If the key type is an SSH certificate type, the rules engine may extract 920 the SSH certificate authority public key and key type 919, and query a database 928 for a public key identifier 927 of the certificate authority based on the public key certificate authority and the public key type. The rules engine may determine if a rule cache entry exists 912 corresponding to the certificate authority public key identifier 927. If the key type is not an SSH certificate type, the rules engine may determine, based on rule cache entry 904, if a rule cache entry exists in the rules engine that corresponds to the rule cache entry 904.

If a corresponding rule cache entry does exist 912, the rules engine may determine if the corresponding rule cache entry signature is valid 930, based on a rule signature database 921. If the signature is not valid, the rules engine may terminate the process and return a null value 939.

If the signature is valid 930, the rules engine may determine if the rule is disabled or deleted 931. If the rule is not disabled or deleted 931, the rules engine may prepare and sign a response 938 based on the active or created rules, and output that response 936.

If a corresponding rule cache entry does not exist 912, the rules engine may query a database 913 for all active rules that correspond to the public key or a public key certificate authority, based on parameters 905, to determine if active rules exist 918.

If the database contains no active rules that that correspond to the computing device or its groups 918, the rules engine may check a rules engine policy 925 to determine if the rules engine is in an observation mode 926. If the rules engine is not in an observation mode, the rules engine may terminate the process and return a null value 924.

If the rules engine is in observation mode 926, the rules engine may determine if the principal's public key is a trusted user certificate authority key 935. If the key is not a trusted user certificate authority key, the rules engine may determine if the principal's key is an authorized key. If the key is not an authorized key, the rules engine may terminate the process and return a null value 924.

If an active rule exists 918 that corresponds to the computing device or its groups, or if the rules engine determines the principal's key is a trusted certificate authority key 935, or is an authorized key 932, the rules engine may prepare and sign a response 938 based on the active or created rules, and output that response 936.

FIG. 10 is a block diagram illustrating an example process 1000 to create a rule entry, consistent with the disclosed embodiments. A central authorization server may start the process 1009. The central authorization server may read the next unprocessed rule from a queue 1010 and output an authorization record 1001 corresponding to the unprocessed rule. The central authorization server may determine if a rule cache entry exists 1011, that corresponds to the unprocessed rule, based on a rule cache entry record 1002. If the rule cache entry exists 1011, the central authorization server may determine if a signature associated with the rule cache entry is valid 10234, based on a record of the rule signature 1019. If the signature associated with the rule cache entry is not valid 1024, the central authorization server may log a record of the invalid cache signature, identifying the invalid cache signature as representing a potential security event 1023, and terminating the process 1029.

If the signature associated with the rule cache entry is valid 1024, the central authorization server may update values in a database 1025 corresponding to an identifier associated with the rule, an identifier associated with a public key, an identifier associated with a principal, and an identifier associated with a computing device. The central authorization server may associate each value in the database with a timestamp 1020. The central authorization server may terminate the process 1029.

If a rule cache entry does not exist 1011, the central authorization server may query a database 1012 for data and identifiers associated with a public key, a principal, a host, and/or a certificate authority public key. If the rule does not exist 1011, the central authorization server may check a policy 1013 to determine if the central authorization server is in observation mode and may observe (i.e., accept and record) unknown parameters (e.g., unknown keys, principals, and hosts, or their identifiers). The system may be configured to observe or not observe any combination of these parameters. If the system is configured to observe unknown parameters, the central authorization server may insert the rule into the database. If the system is configured to not observe unknown parameters 1013 that are necessary to create the unprocessed rule, the system may terminate without creating a rule.

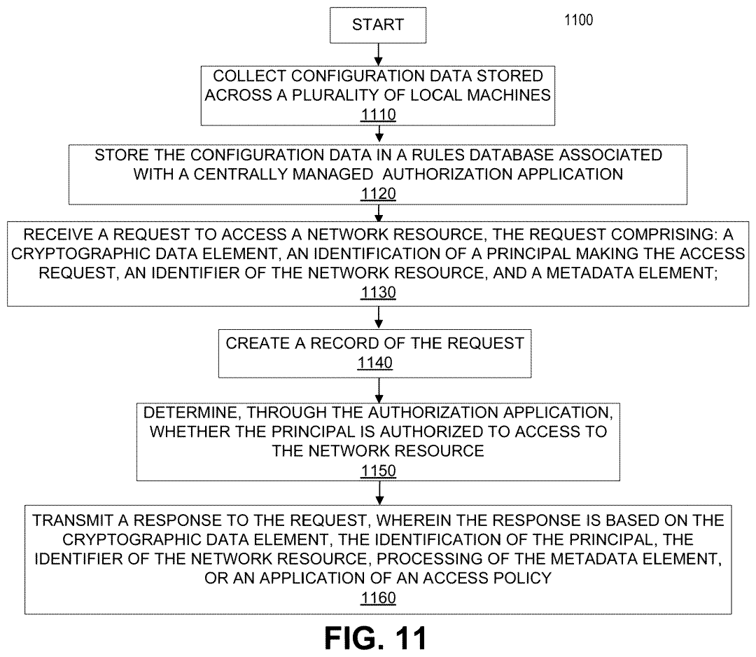

FIG. 11 is a flowchart showing an example process 1100 for secure shell access, consistent with the disclosed embodiments. Process 1100 may be performed by at least one processor of a computing device, such as processor 210 described above. It is to be understood that throughout the present disclosure, the term “processor” is used as a shorthand for “at least one processor.” In other words, a processor may include one or more structures that perform logic operations whether such structures are collocated, connected, or dispersed. In some embodiments, a non-transitory computer readable medium may contain instructions that when executed by a processor cause the processor to perform process 1100. Further, process 1100 is not necessarily limited to the steps shown in FIG. 11, and any steps or processes of the various embodiments described throughout the present disclosure may also be included in process 1100, including those described above with respect to, for example, FIGS. 3-10.

In step 1110, process 1100 may include collecting configuration data stored across a plurality of local machines.

In step 1120, process 1100 may include storing the configuration data in a rules database associated with a centrally managed authorization application.

In step 1130, process 1100 may include receiving a request to access a network resource, the request comprising: a cryptographic data element, an identification of a principal making the access request, an identifier of the network resource, and a metadata element.

In step 1140, process 1100 may include creating a record of the request.

In step 1150, process 1100 may include determining, through an authorization application including a rules database, whether the principal is authorized to access the network resource.

In step 1160, process 1100 may include transmitting a response to the request, wherein the response is based on the cryptographic data element, the identification of the principal, the identifier of the network resource, processing of the metadata element, or an application of an access policy.

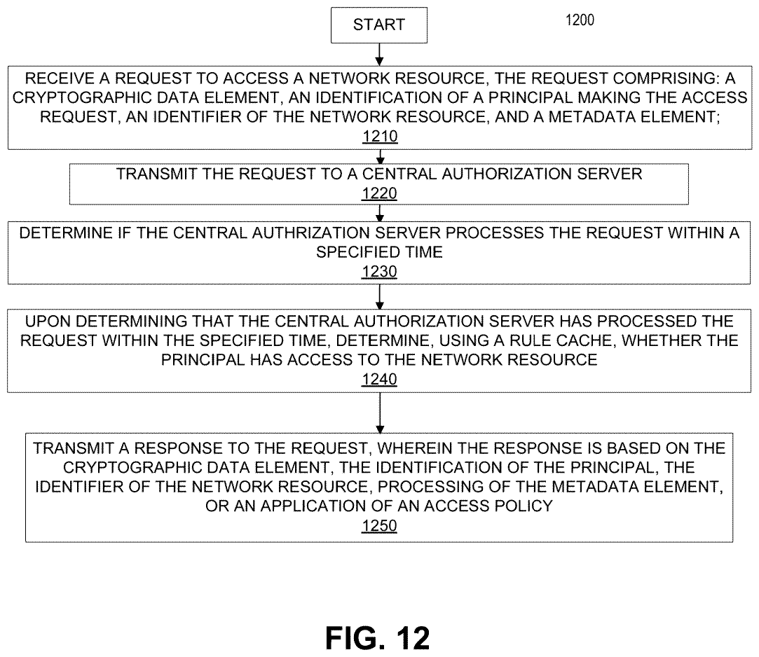

FIG. 12 is a flowchart showing an example process 1200 for secure shell access, consistent with the disclosed embodiments. Process 1200 may be performed by at least one processor of a computing device, such as processor 210 described above. It is to be understood that throughout the present disclosure, the term “processor” is used as a shorthand for “at least one processor.” In other words, a processor may include one or more structures that perform logic operations whether such structures are collocated, connected, or dispersed. In some embodiments, a non-transitory computer readable medium may contain instructions that when executed by a processor cause the processor to perform process 1200. Further, process 1200 is not necessarily limited to the steps shown in FIG. 12, and any steps or processes of the various embodiments described throughout the present disclosure may also be included in process 1200, including those described above with respect to, for example, FIGS. 3-11.

In step 1210, process 1200 may include receiving a request to access a network resource, the request comprising: a cryptographic data element, an identification of a principal making the access request, an identifier of the network resource, and a data element.

In step 1220, process 1200 may include transmitting the request to a central authorization server.

In step 1230, process 1200 may include determining if the central authorization server processes the request within a specified time.

In step 1240, process 1200 may include upon determining that the central authorization server has processed the request within the specified time, determining, using a rule cache, whether the principal has access to the network resource.

In step 1250, process 1200 may include transmitting a response to the request, wherein the response is based on the cryptographic data element, the identification of the principal, the identifier of the network resource, processing of the data element, and an application of an access policy.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials, and code types will be developed, and the scope of these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A non-transitory computer readable medium including instructions that, when executed by at least one processor, cause the at least one processor to perform operations for providing centralized authorization of one or more cryptographic data elements, the operations comprising:
collecting configuration data stored across a plurality of local machines;
storing the configuration data in a rules database associated with a centrally managed authorization application;
receiving a request to access a network resource, the request comprising: a cryptographic data element, an identification of a principal making the access request, an identifier of the network resource, and a metadata element;
creating a record of the request;
determining, through the authorization application, whether the principal is authorized to access the network resource; and
transmitting a response to the request, wherein the response is based on the cryptographic data element, the identification of the principal, the identifier of the network resource, processing of the metadata element, or an application of an access policy.

2. The non-transitory computer readable medium of claim 1, wherein the operations further comprise at least one of: creating a new authorization rule or updating an existing authorization rule, based on the record of the request.

3. The non-transitory computer readable medium of claim 2, wherein creating the new authorization rule comprises:
determining that an authorization rule does not exist, based on a query to the rules database, wherein the query includes the cryptographic data element, the identification of the principal, and the identifier of the network resource; and
creating the new authorization rule based on the cryptographic data element, the identification of the principal, the identifier of the network resource, or the processing of the metadata.

4. The non-transitory computer readable medium of claim 2, wherein updating the existing authorization rule comprises:
determining that an authorization rule exists, based on a query to the rules engine, wherein the query includes the cryptographic data element, the identification of the principal, or the identifier of the network resource; and
updating the existing authorization rule based on the cryptographic data element, the identification of the principal, the identifier of the network resource, or the processing of the metadata.

5. The non-transitory computer readable medium of claim 1, wherein determining whether the principal has access to the network resource comprises querying the rules engine with the cryptographic data element, the identification of the principal, and the identifier of the network resource.

6. The non-transitory computer readable medium of claim 1, wherein determining whether the principal has access to the network resource comprises querying the rules database with an authorization rule identifier.

7. The non-transitory computer readable medium of claim 1, wherein the cryptographic data element comprises a public key corresponding to a private key.

8. The non-transitory computer readable medium of claim 1, wherein the cryptographic data element comprises:
at least one of: a timestamp, the principal, a principal identifier, the network resource, a network resource identifier, the cryptographic data element, a cryptographic data element identifier, an authorization rule identifier, or a representation of an authorization rule locally configured to the network resource; and
a cryptographic signature derived by at least one of: a symmetric encryption algorithm, a hashing algorithm, a symmetric key or token, or a signature based on an asymmetric key or certificate.

9. The non-transitory computer readable medium of claim 1, wherein the operations further comprise authorizing the principal.

10. The non-transitory computer readable medium of claim 1, wherein the metadata element identification is determined by comparing the cryptographic data element to a directory of authorized cryptographic data elements associated with the principal.

11. A computer-implemented method for providing centralized authorization of one or more cryptographic data elements, comprising the operations of:
collecting configuration data stored across a plurality of local machines;
storing the configuration data in a rules database associated with a centrally managed authorization application;
receiving a request to access a network resource, the request comprising: a cryptographic data element, an identification of a principal, an identifier of the network resource associated with the principal, and a data element;
creating a record of the request;
determining, through a rules database, whether the principal has access to the network resource; and
transmitting a response to the request, wherein the response is based on the cryptographic data element, the identification of the principal, the identifier of the network resource, processing of the data element, and an application of an access policy.

12. The computer-implemented method of claim 11, further comprising at least one of:
creating a new authorization rule or updating an existing authorization rule based on the record of the request.

13. The computer-implemented method of claim 12, wherein creating the new authorization rule comprises:
determining that an authorization rule does not exist, based on a query to the rules database, wherein the query includes the cryptographic data element, the identification of the principal, and the identifier of the network resource; and
creating the new authorization rule based on the cryptographic data element, the identification of the principal, the identifier of the network resource, and the processing of the data element.

14. The computer-implemented method of claim 12, wherein updating the existing authorization rule comprises:
determining that an authorization rule exists, based on a query to the rules engine, wherein the query includes the cryptographic data element, the identification of the principal, and the identifier of the network resource; and
updating the existing authorization rule based on the cryptographic data element, the identification of the principal, the identifier of the network resource, and the processing of the data element.

15. The computer-implemented method of claim 11, wherein determining whether the principal has access to the network resource comprises querying the rules engine with the cryptographic data element, the identification of the principal, and the identifier of the network resource.

16. The computer-implemented method of claim 11, wherein determining whether the principal has access to the network resource comprises querying the rules database with an authorization rule identifier.

17. The computer-implemented method of claim 11, wherein the cryptographic data element comprises a public key corresponding to a private key.

18. The computer-implemented method of claim 11, wherein the cryptographic data element comprises:
at least one of: a timestamp, the principal, a principal identifier, the network resource, a network resource identifier, the cryptographic data element, a cryptographic data element identifier, an authorization rule identifier, or a representation of an authorization rules locally configured to the network resource; and
a cryptographic signature derived by at least one of: a symmetric encryption algorithm, a hashing algorithm, a symmetric key or token, or a signature based on an asymmetric key or certificate.

19. The computer-implemented method of claim 11, further comprising authorizing the principal.

20. The computer-implemented method of claim 11, wherein the data element identification is determined by comparing the cryptographic data element to a directory of authorized cryptographic data elements associated with the principal.
